(19) United States
(12) Patent Application Publication
(10) Pub. No.: US 2014/0185710 A1
(43) Pub. Date: Jul. 3, 2014

(54) APPARATUS AND METHOD OF PROVIDING TRAFFIC INFORMATION USING RADIO TRAFFIC BROADCASTING

(71) Applicant: HYUNDAI MOTOR COMPANY, Seoul (KR)

(72) Inventor: Jae Woo Park, Anyang (KR)

(73) Assignee: HYUNDAI MOTOR COMPANY, Seoul (KR)

(21) Appl. No.: 13/905,395

(22) Filed: May 30, 2013

(30) Foreign Application Priority Data
Dec. 28, 2012 (KR) 10-2012-0156613

(51) Int. Cl. H04H 20/55

(52) U.S. Cl. CPC H04H 20/55
USPC 375/336

(57) ABSTRACT

An apparatus and a method that provide traffic information using radio traffic broadcasting that provides corresponding traffic information to a driver when the driver requests the corresponding traffic information, without requiring a separate digital modulation module, by recording radio traffic broadcasting in a streaming scheme. In addition, corresponding traffic broadcasting is extracted and stored in a file form when a street name, a land mark, a location name, or the like, on a destination path set by the driver is recognized as an audio in the recorded radio traffic broadcasting.

### CROSS-REFERENCE TO RELATED APPLICATION

This application is based on and claims priority from Korean Patent Application No. 10-2012-0156613, filed on Dec. 28, 2012 in the Korean Intellectual Property Office, the disclosure of which is incorporated herein in its entirety by reference.

### BACKGROUND OF THE INVENTION

1. Field of the Invention

The present invention relates to an apparatus and a method that provide traffic information using radio traffic broadcasting, and more particularly, to a technology that provides corresponding traffic information to a driver when the driver requests the corresponding traffic information by recording radio traffic broadcasting in a streaming scheme and extracting corresponding traffic broadcasting and storing the extracted traffic broadcasting in a file form when a street name, a land mark, a location name, or the like, on a destination path set by the driver is recognized as an audio in the recorded radio traffic broadcasting.

2. Description of the Prior Art

A data radio channel (DARC), which is a type of frequency modulation (FM) additional broadcasting service, indicates a system carrying digital information on a margin portion of an FM frequency to provide various additional services such as news, stock, weather, traffic information, and the like, together with FM broadcasting. In other words, the DARC is an additional service in which data and an audio in a digital form are simultaneously transmitted using a frequency that is not used in a frequency band allocated for FM broadcasting.

To provide the DARC service, a large capacity data must be accommodated and audio broadcasting must be received without hindering existing FM stereo audio broadcasting. Therefore, digital modulation is an important factor and the DARC has used a level controlled minimum shift keying (LMSK) scheme, which is a digital modulation scheme developed for FM additional broadcasting.

For reference, the LMSK scheme, which is a scheme devised for an FM additional service in which a synthetic signal of a stereo generator is input to an DARC encoder, such that a modulation level of a sub-carrier is tuned according to a modulation level of a baseband, is a wireless data communication technology that provides various information without allocation of a new frequency and provides a wide service area, a perfect networking function, and the like.

In the DARC as described above, wireless data may be received in real time during movement, a cost may be reduced due to use of a terrestrial radio network that has been already built, the area property may be increased since information may be received at any place at which a radio frequency is received, and the speed of receiving real time information may be increased. However, to receive traffic information provided through the DARC, a separate digital modulation module such as the LMSK may be required.

### SUMMARY

Accordingly, the present invention provides an apparatus and a method that provide traffic information using radio traffic broadcasting to provide corresponding traffic information to a driver when the driver requests the corresponding traffic information, without requiring a separate digital modulation module, by recording radio traffic broadcasting in a streaming scheme and extracting corresponding traffic broadcasting and storing the extracted traffic broadcasting in a file form when a street name, a land mark, a location name, or the like, on a destination path set by the driver is recognized as an audio in the recorded radio traffic broadcasting.

In one aspect of the present invention, an apparatus that provides traffic information using radio traffic broadcasting may include a plurality of units executed by a controller. The plurality of units may include: a traffic broadcasting receiving unit configured to receive traffic broadcasting; a traffic broadcasting storing unit configured to store the traffic broadcasting received by the traffic broadcasting receiving unit; a path setting unit configured to receive destination information from a driver to set a path from a current position to a destination and create a list of names on the set path; a traffic information extracting unit configured to extract corresponding traffic information when the name on the list is included in the traffic broadcasting stored in the traffic broadcasting storing unit; wherein the traffic information extracting unit may be configured to extract the corresponding traffic information in the traffic broadcasting stored in the traffic broadcasting storing unit; and a traffic information storing unit configured to store the traffic information extracted by the traffic information extracting unit.

In another aspect of the present invention, a method that provides traffic information using radio traffic broadcasting may include: receiving, by a controller, traffic broadcasting; storing, by the controller, the received traffic broadcasting; receiving, by the controller, destination information from a driver to set a path from a current position to a destination and creating a list of names on the set path; determining, by the controller, whether the name on the list is included in the stored traffic broadcasting; extracting, by the controller, corresponding traffic information when the name on the list is included in the stored traffic broadcasting; and storing by the controller, the extracted traffic information.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram of an apparatus that provides traffic information using radio traffic broadcasting according to an exemplary embodiment of the present invention;

FIG. 2 is an exemplary diagram of path setting and list creating results according to the exemplary embodiment of the present invention; and

FIG. 3 is an exemplary flow chart of a method that provides traffic information using radio traffic broadcasting according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, exemplary embodiments of the present invention will be described in detail with reference to the accompanying drawings.

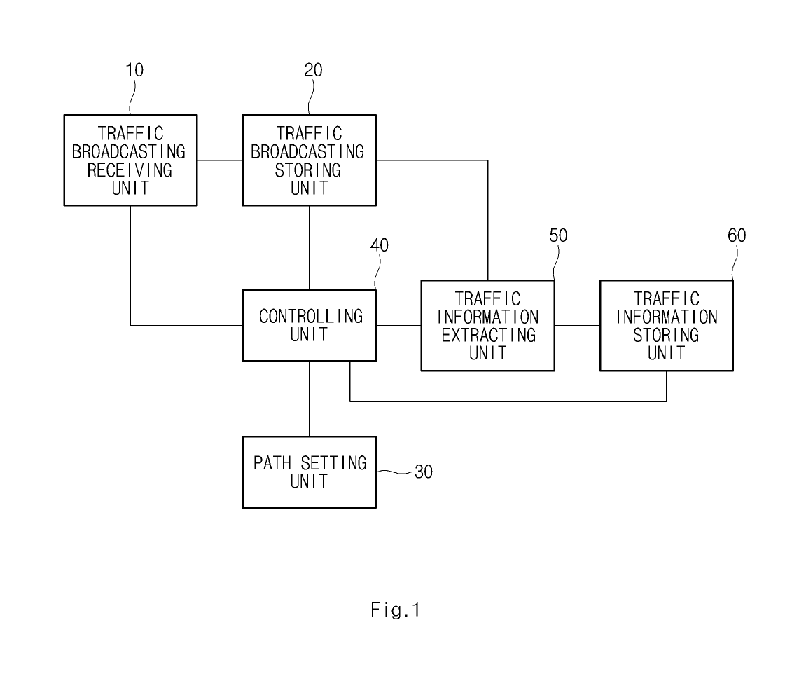

FIG. 1 is an exemplary diagram of an apparatus that provides traffic information using radio traffic broadcasting according to an exemplary embodiment of the present invention. As shown in FIG. 1, the apparatus that provides traffic information using radio traffic broadcasting may include a plurality of units executed by a controller 40. The plurality of units may include: a traffic broadcasting receiving unit 10, a traffic broadcasting storing unit 20, a path setting unit 30, a traffic information extracting unit 50, and a traffic information storing unit 60.

The above-mentioned respective units will be described. First, the traffic broadcasting receiving unit 10 may further include a traffic broadcasting tuner configured to receive traffic broadcasting separately from a general broadcasting tuner that receives general radio broadcasting to continuously receive the traffic broadcasting selected by the traffic broadcasting tuner. For reference, the traffic broadcasting, which is FM broadcasting, uses a frequency of 95.1 MHz in Seoul, a frequency of 94.9 MHz in Pusan, a frequency of 103.9 MHz in Daegu, a frequency of 100.5 MHz in Incheon, and a frequency of 102.5 MHz in Jeonju. Currently, a radio broadcasting station separately schedules the traffic broadcasting, and a driver may continuously receive the traffic broadcasting through the traffic broadcasting tuner even when a desired broadcasting is heard through the general broadcasting tuner.

The traffic broadcasting storing unit 20 may be configured to store the traffic broadcasting received by the traffic broadcasting receiving unit 10 in a streaming scheme. In particular, the streaming, which is a technology that reproduces an audio, a moving picture, or the like, in real time on the Internet, is a technology that processes transmitted data like a seamless continuous water flow.

The path setting unit 30 may be configured to operate with a navigation system mounted within a vehicle to receive destination information from the driver, thereby setting a path from a current position to a destination, and create a list of names (e.g., street names, land marks, location names, or the like) on the set path. Specifically, the land mark may be preset by an interface designer and may be subsequently set by the driver.

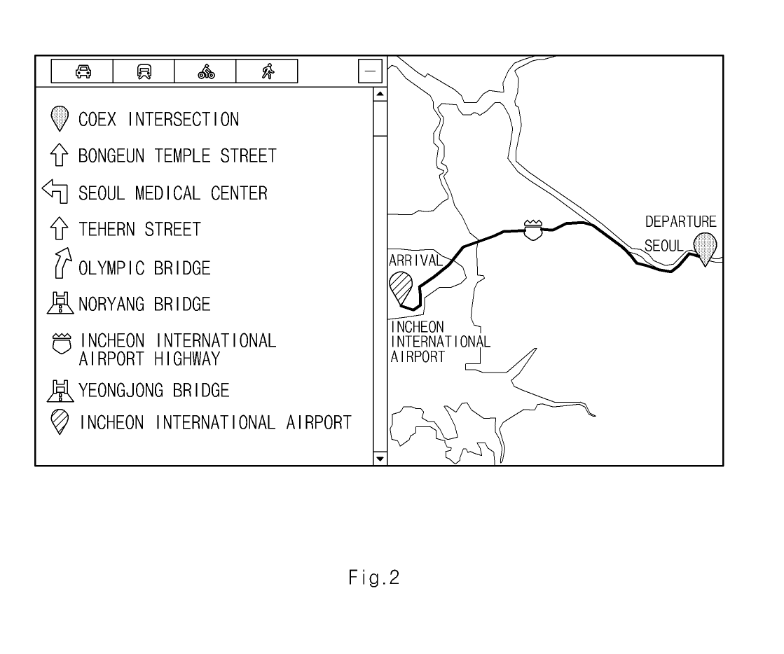

Describing an example of FIG. 2 which illustratively shows an exemplary created path when a driver positioned at a COEX intersection sets Incheon International Airport as the destination, a list created based on street names, land marks, location names, or the like, on a path from the COEX intersection to the Incheon International Airport may include Bongeun Temple Street, Seoul Medical Center, Teheran Street, Olympic Bridge, Noryang Bridge, Incheon International Airport highway, Yeongjong Bridge, and the like.

The path setting unit 30 may further include a separate list creator, executed by the controller 40 to create a list of the street names, the land marks, the place names, or the like, on the path set as described above. In addition, the controller 40 may be configured to store the radio traffic broadcasting in the streaming scheme and execute the above-mentioned respective units to extract corresponding traffic broadcasting and store the extracted traffic broadcasting in a file form when the name (e.g., the street name, the land mark, the location name, or the like) of the destination path set by the driver is recognized as an audio in the stored radio traffic broadcasting. Particularly, the controller 40 may be configured to execute the traffic information extracting unit 50 to extract corresponding traffic information when the name on the list created by the path setting unit 30 is included in the traffic broadcasting stored in the traffic broadcasting storing unit 20, based on a real time audio recognizing technology. In other words, the controller 40 may be configured to analyze the traffic broadcasting continuously stored in the traffic broadcasting storing unit 20 using the audio recognizing technology to determine whether the name on the list created by the path setting unit 30 is included in the traffic broadcasting.

Referring to FIG. 2, when traffic broadcasting such as, ‘it is expected that traffic flows on Olympic Street in both directions will become smooth after ten o'clock,” is received, the controller 40 may be configured to recognize ‘Olympic Street’ as an audio to execute the traffic information extracting unit 50 to extract the traffic broadcasting as traffic information. In this case, the traffic information extracting unit 50 may be configured to extract the corresponding traffic information in the traffic broadcasting stored in the traffic broadcasting storing unit 20. Specifically, when the above mentioned traffic broadcasting continues, the traffic information extracting unit 50 may be configured to extract only a corresponding sentence as the traffic information. In other words, the traffic information extracting unit may be configured to extract a sentence in which the name on the list is included as the traffic information.

The traffic information storing unit 60 may be configured to store the traffic information extracted by the traffic information extracting unit 50 in the file form. Since the traffic information file stored as described above includes date, time, and name information of the list, the controller 40 may be configured to selectively provide only traffic information requested by the driver. In addition, the controller 40 may be configured to provide a rewind function, a forward function, and a skip function according to a request of the driver at the time of reproducing the traffic information file.

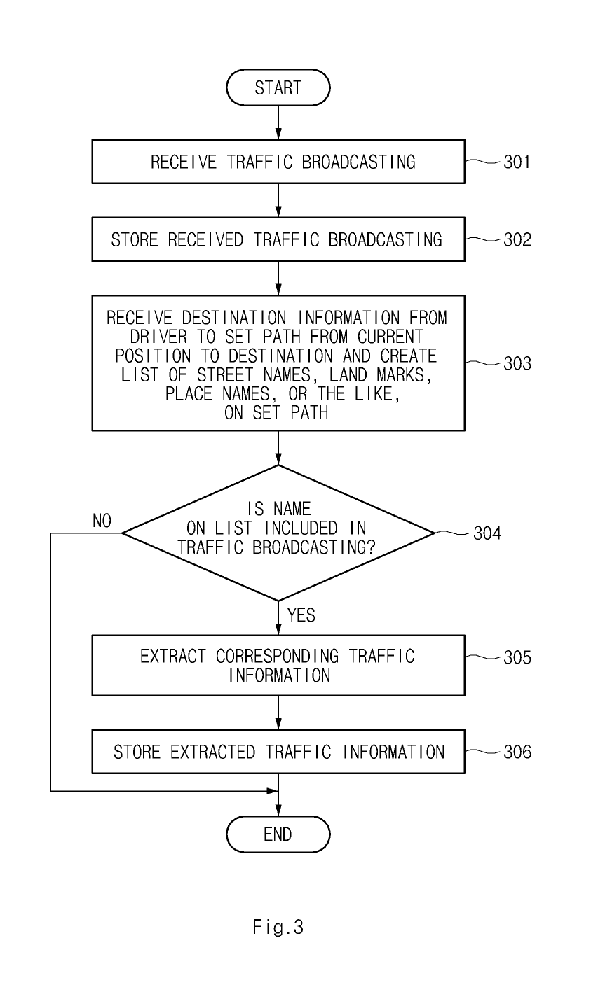

FIG. 3 is an exemplary flow chart of a method that provides traffic information using radio traffic broadcasting according to the exemplary embodiment of the present invention. The method may include: receiving, by a controller, traffic broadcasting (301); storing, by the controller, the received traffic broadcasting (302); receiving, by the controller, destination information from a driver to set a path from a current position to a destination and creating a list of street names, land marks, place names, or the like, on the set path (303); inspecting, by the controller, whether the name on the list is included in the stored traffic broadcasting (304); extracting, by the controller, the corresponding traffic information (305) when the name on the list is included in the stored traffic broadcasting; and storing, by the controller, the extracted traffic information (306).

Through the above-mentioned process, the corresponding traffic information may be provided when requested by the driver, without requiring a separate digital modulation module.

As set forth above, according to the exemplary embodiments of the present invention, the radio traffic broadcasting may be recorded in the streaming scheme and the corresponding traffic broadcasting may be extracted and stored in a file form when the street name, the land mark, the place name, or the like, on the destination path set by the driver is recognized as the audio in the recorded radio traffic broadcasting, thereby providing the corresponding traffic information to the driver when the driver requests the corresponding traffic information, without requiring the separate digital modulation module.

What is claimed is:

1. An apparatus that provides traffic information using radio traffic broadcasting, comprising:
a controller configured to:
receive traffic broadcasting;
store the received traffic broadcasting;
receive destination information from a driver to set a path from a current position to a destination and create a list of names on the set path;
extract corresponding traffic information when the name on the list is included in the stored traffic broadcasting;
extract the corresponding traffic information in the stored traffic broadcasting; and
store the extracted traffic information.

2. The apparatus according to claim 1, wherein the controller is further configured to:
store the received traffic broadcasting in a streaming scheme.

3. The apparatus according to claim 1, wherein the controller is further configured to:
extract a sentence including a street name, a land mark, and a location name as the name on the list as the traffic information.

4. The apparatus according to claim 1, wherein the controller is further configured to:
store the extracted traffic information in a file form.

5. A method that provides traffic information using radio traffic broadcasting, comprising:
receiving, by a controller, traffic broadcasting;
storing, by the controller, the received traffic broadcasting;
receiving, by the controller, destination information from a driver to set a path from a current position to a destination and creating a list of names on the set path;
inspecting, by the controller, whether the name on the list is included in the stored traffic broadcasting;
extracting, by the controller, corresponding traffic information when the name on the list is included in the stored traffic broadcasting; and
storing by the controller, the extracted traffic information.

6. The method according to claim 5, wherein in the storing of the received traffic broadcasting, the received traffic broadcasting is stored in a stream scheme.

7. The method according to claim 5, wherein in the extracting of the corresponding traffic information, a sentence including a street name, a land mark, and a location name as the name on the list is extracted as the traffic information.

8. The method according to claim 5, wherein in the extracting of the corresponding traffic information, a sentence including at least one of a street name, a land mark, and a location name as the name on the list is extracted as the traffic information.

9. The method according to claim 5, wherein in the storing of extracted traffic information, the extracted traffic information is stored in a file form.

10. A non-transitory computer readable medium containing program instructions executed by a controller, the computer readable medium comprising:
program instructions that receive traffic broadcasting;
program instructions that store the received traffic broadcasting;
program instructions that receive destination information from a driver to set a path from a current position to a destination and create a list of names on the set path;
program instructions that inspect whether the name on the list is included in the stored traffic broadcasting;
program instructions that extract corresponding traffic information when the name on the list is included in the stored traffic broadcasting; and
program instructions that store the extracted traffic information.

11. The non-transitory computer readable medium of claim 10, further comprising:
program instructions that store the received traffic broadcasting in a streaming scheme.

12. The non-transitory computer readable medium of claim 10, further comprising:
program instructions that extract a sentence including a street name, a land mark, and a location name as the name on the list as the traffic information.

13. The non-transitory computer readable medium of claim 10, further comprising:
program instructions that extract a sentence including at least one of a street name, a land mark, and a location name as the name on the list as the traffic information.

14. The non-transitory computer readable medium of claim 10, further comprising:
program instructions that store the extracted traffic information in a file form.
